(19) United States
(12) Patent Application Publication
(10) Pub. No.: US 2020/0002499 A1
(43) Pub. Date: Jan. 2, 2020

(54) METHOD FOR PHYSICALLY FOAMING A POLYMER MATERIAL AND FOAMED ARTICLE

(71) Applicant: Dongguan Hailex Polymer Material Science And Technology Co., Ltd., Dongguan (CN)

(72) Inventors: Zhenhuan Luo, Dongguan (CN); Fuqi Liu, Dongguan (CN)

(21) Appl. No.: 16/152,682

(22) Filed: Oct. 5, 2018

(30) Foreign Application Priority Data
Jun. 29, 2018 (CN) 201810699146.8

(51) Int. Cl. C08J 9/12; C08J 9/00; C08J 3/24; B29B 11/06; B29C 44/02

(52) U.S. Cl. CPC C08J 9/122; C08J 9/0066; C08J 9/0061; C08J 3/24; B29B 11/06; B29C 44/02; B29K 2023/083; C08J 2203/08; C08J 2201/026; C08J 2205/10; C08J 2323/08; C08J 2491/06; C08J 2423/00; C08J 2203/06

(57) ABSTRACT

The present disclosure relates to a method for physically foaming a polymer material and a foamed article. The method for physically foaming a polymer material comprises: (1) making a thermoplastic elastomer or a polyolefin material into a blank with an injector, an extruder, or a molding press; (2) subjecting the polyolefin blank to a crosslinking reaction to obtain a crosslinked polyolefin blank; (3) subjecting the thermoplastic elastomer blank or the crosslinked polyolefin blank to a high pressure impregnation with a supercritical fluid in an autoclave, then releasing the pressure to a normal pressure to obtain a supercritical fluid-impregnated blank; and (4) placing the supercritical fluid-impregnated blank into an end-product mold to perform an 1:1 in-mold foaming to obtain a finished foam article.

### CROSS REFERENCE

This disclosure claims priority benefits from Chinese Patent Application No. 201810699146.8 filed on Jun. 29, 2018, which is incorporated by reference herein in its entirety.

### TECHNICAL FIELD

The present disclosure relates to the field of polymer material, and particularly to a method for physically foaming a polymer material and a foamed article.

### BACKGROUND

Foaming process is one of commonly used processes for preparing a material is with a low density. Foaming process can be classified into chemically foaming process and physically foaming process depending on the foaming agent used. Conventional preparation of a polyolefin chemically foamed material with a low density needs to use a chemical foaming agent, and has the following disadvantages: it does not comply with the environmental protection requirement; and there are harmful substances in the decomposition product of the foaming agent, not complying with the relevant safety regulations. Conventionally, main methods for preparing a polyolefin physically foamed material include a gas-assisted injection molding method, an extrusion molding method and the like, with an alkane gas, a volatile compound, CO₂, N₂ (for example, Mucell technology) or the like being used as a physical foaming agent. Mucell technology is created by Trexcel Corporation, USA, and comprises connecting an apparatus for producing a supercritical fluid to a barrel of an injection molding machine or an extruder, injecting the supercritical fluid into the barrel of the injection molding machine or the extruder to mix it with a polymer material in the barrel, and then injection molding the polymer melt plastic mixed with the supercritical fluid into a plastic mold for injection molding or extrusion molding, to obtain a light-weight injection molded product or extruded product.

A special-shaped physically foamed material prepared by the above method usually has the disadvantages of high density (about 0.4 or more), low rebound ability, poor tactile feeling, and insufficiently flat and smooth surface appearance with gas marks, and is not suitable for fabricating a shoe material and a product with a cushioning effect, such as a floor mat, a sport equipment, and the like. It does not completely comply with environmental protection requirements to use an alkane gas (such as butane, pentane, hexane, and the like) or a volatile compound as a physical foaming agent. Further, conventional preparation of a polyolefin physically or chemically foamed article comprises foaming outside mold and then placing into an end-product mold to perform a secondary processing, so the process is tedious and time-consuming.

### SUMMARY

In the present disclosure, an environment-friendly, nontoxic foamed material with a low density and good rebound ability is obtained through a simple in-mold foaming process with a supercritical fluid as physical foaming agent.

One aspect of the present disclosure provides a method for physically foaming a polymer material, comprising:

(1) making a thermoplastic elastomer or a polyolefin material into a thermoplastic elastomer blank or a polyolefin blank with an injector, an extruder, or a molding press;

(2) subjecting the polyolefin blank to a crosslinking reaction to obtain a crosslinked polyolefin blank;

(3) subjecting the thermoplastic elastomer blank or the crosslinked polyolefin blank to a high pressure impregnation with a supercritical fluid at a pressure of 10-50 MPa in an autoclave, then releasing the pressure to a normal pressure to obtain a supercritical fluid-impregnated blank; and

(4) placing the supercritical fluid-impregnated blank into an end-product mold to perform an 1:1 in-mold foaming to obtain a finished foam article.

Another aspect of the present disclosure provides a foamed article obtained by the above method for physically foaming a polymer material, having a rebound degree of 50% or more as measured according to ASTM D2632.

In the present disclosure, an environment-friendly, nontoxic foamed material with a low density, good rebound ability, and a flat and smooth surface appearance is obtained through a simple in-mold foaming process with a supercritical fluid as physical foaming agent. The special-shaped foamed material of the present disclosure is environmental friendly, nontoxic, and recyclable, completely complying with the current trend. Since a final article can be obtained by one step foaming-molding without a secondary processing, the present disclosure can achieve the objects of reducing human resources and saving energy simultaneously.

### DETAILED DESCRIPTION

The method for physically foaming a polymer material of the present disclosure comprises: preparing a thermoplastic elastomer or polyolefin blank (for the polyolefin blank, it may be subjected to a crosslinking reaction to obtain a crosslinked polyolefin blank); subjecting the above blank to a high pressure impregnation with a supercritical fluid to obtain a supercritical fluid-impregnated blank; and then subjecting the supercritical fluid-impregnated blank to an 1:1 in-mold foaming to obtain a finished foam article.

### —Starting Materials—

Starting materials useful in the polymer material physically foaming process of the present disclosure comprise a thermoplastic elastomer and a polyolefin material.

The thermoplastic elastomer may comprise at least one of a thermoplastic polyurethane (TPU), a thermoplastic polyester elastomer (TPEE), and a polyether block amide elastomer (Pebax), or a mixture thereof.

The polyolefin material may comprise at least one of poly(ethylene-co-vinyl acetate) (EVA), a polyolefin elastomer (POE), and a low density polyethylene (LDPE), or a mixture thereof. For example, the polyolefin material may be EVA, wherein the molar content of vinyl acetate is 5-40%, or may be a mixture of EVA/POE with a mixing ratio of 100/0.1˜0.1/100, or may be a blend of a polyolefin material and a rubber material, such as an EVA/POE/EPDM (ethylene-propylene-diene-terpolymer rubber) blend with a mixing ratio of 100/0.1/0.1˜0.1/100/20.

The polyolefin material may be doped with at least one of a crosslinking agent, a filler and an auxiliary agent. Here, relative to 100 phr (part by weight) of the polyolefin material, the crosslinking agent may have an amount of 1.2 phr or less, for example, 0.15-1.1 phr, preferably 0.25-1.0 phr, the filler may have an amount of 20 phr or less, and the auxiliary agent may have an amount of 5 phr or less.

The crosslinking agent may comprise a peroxide, such as dicumyl peroxide (DCP) and bis(tert-butylperoxyisopropyl)benzene (BIPB).

The filler may comprise at least one of calcium carbonate, talc, mica, pottery clay, zinc oxide, and titanium oxide.

The auxiliary agent may comprise at least one of paraffin, stearic acid or a salt is thereof (zinc salt or calcium salt), or another long-chain fatty acid.

### —Preparation of a Blank—

In the method of physically foaming a polymer material of the present disclosure, the above starting material (the thermoplastic elastomer or polyolefin material) is made into a blank with an injector, an extruder, or a molding press.

The preparation of the blank may be performed under a suitable condition. For example, for the polyolefin material to be crosslinked, a molding is performed at a mold temperature of 160-180° C. and a suitable mold clamping pressure of e.g. about 10 MPa for 400-550 seconds.

In the present disclosure, the shape of the blank is not particularly limited. Generally, the blank may be sheet-like, particulate, and so on.

After forming the blank, the polyolefin material may be subjected to a crosslinking reaction in order to increase the molecular chain strength of the polyolefin material. The crosslinking reaction may be performed with a chemical crosslinking process and/or an electron beam irradiation process. For example, the polyolefin blank may be crosslinked and molded at a temperature of 170-180° C. (by means of the crosslinking agent contained in the polyolefin composition), and a vulcanization curve measured with a vulcameter may be used as a reference for the crosslinking and molding. The crosslinking may also be performed through an electron beam irradiation process, for example, by irradiating with 20-50 kGy (kilogrey) of high energy electron beam.

### —Supercritical Fluid High Pressure Impregnation—

The method for physically foaming a polymer material of the present disclosure further comprises subjecting the above blank to a high pressure impregnation with a supercritical fluid to obtain a supercritical fluid-impregnated blank.

For example, the thermoplastic elastomer blank or the crosslinked polyolefin blank may be subjected to a high pressure impregnation with a supercritical fluid in an autoclave, and then the pressure is released to a normal pressure, to obtain a supercritical fluid-impregnated blank.

The supercritical fluid may comprise carbon dioxide supercritical fluid, nitrogen supercritical fluid, and the like.

The high pressure impregnation may be performed at a pressure of 10-50 MPa and a temperature of 40-150° C. for 0.5-8 hours, preferably 1-5 hours.

The pressure releasing to a normal pressure after the high pressure impregnation is usually controlled within 15-40 minutes to meet the production efficiency requirement and control the pre-foaming (pre-foaming ratio is controlled to be 1-1.4, where 1 represents no pre-foaming).

In the resultant supercritical fluid-impregnated blank, the impregnation amount of the supercritical fluid in the blank is 0.6-15% by weight, preferably 0.8-10% by weight.

### —In-Mold Foaming—

The method for physically foaming a polymer material of the present disclosure further comprises foaming and molding the supercritical fluid-impregnated blank in one step to obtain a final product.

For example, the above supercritical fluid-impregnated blank may be placed into an end-product mold to perform an 1:1 in-mold foaming to obtain a finished foam article.

The condition for the in-mold foaming may comprise a temperature of 70-150° C. and a foaming time of 5-30 minutes.

The ratio between the linear dimension of the blank before the in-mold foaming (the linear dimension is usually defined in a length direction) and the product dimension after the in-mold foaming may be 1:1.5˜1:3.5, preferably 1:1.7˜1:2.5.

After the in-mold foaming, the density of the foamed material may be decreased from the initial about 1.0 g/cm³ to 0.30 g/cm³ or less, preferably 0.25 g/cm³ or less, and more preferably 0.20 g/cm³ or less.

The foamed article has a rebound degree of 50% or more as measured according to ASTM D2632.

### —Foamed Article—

The present disclosure also provides a foamed article obtained by the above method for physically foaming a polymer material.

The formed article of the present disclosure has a cell diameter of 0.1-3 mm and a density of 0.03-0.30 g/cm³.

The foamed article of the present disclosure may be used in a floor mat, a shoe material, a sport equipment, a toy or a packaging material.

In the present disclosure, an environment-friendly, nontoxic foamed material with a low density, a good rebound ability, and a flat and smooth surface appearance is obtained through a simple in-mold foaming process with a supercritical fluid as physical foaming agent. The final article is obtained with one step foaming-molding without a secondary processing, so the objects of reducing human resources and saving energy can be achieved simultaneously.

The present disclosure will be further described below through examples and comparative examples. However, the present disclosure is not limited to these examples and comparative examples in any way.

### EXAMPLE 1

100 phr of EVA (EVA7470 from Formosa Plastic, with a molar content of vinyl acetate of 26%), 1 phr of calcium carbonate, 0.5 phr of paraffin, and 0.5 phr of DCP were mixed under conditions of a temperature of 100° C. and a pressure of 0.75 MPa in a Banbury mixer ST-75L (from Santai Machinery Company) for 12 min. After discharging, the above mixture was extruded and granulated with an extrusion granulator which matches the Banbury mixer ST-75L. The colloidal particles were crosslinked and molded at a mold temperature of 180° C. in a KM-E308L3 EVA injector (from Jumin Machinery Company).

The crosslinked polyolefin blank was placed into an autoclave, a carbon dioxide supercritical fluid was injected thereto, and maintained at a pressure of 40 MPa and a temperature of 50° C. for 2 hours. Then, the pressure was released to a normal pressure over 30 min, to obtain a supercritical fluid-impregnated blank (with a pre-foaming ratio of 1.5 or less), and the impregnation amount of the supercritical fluid in the blank is 10% by weight.

The above supercritical fluid-impregnated blank was placed into an end-product mold, and subjected to an in-mold foaming at a temperature of 140° C. for 15 min, to obtain a finished foam article with a flat and smooth surface appearance. The foaming ratio, as a ratio between the linear dimension of the blank in a length is direction before foaming and the dimension of the product after the in-mold foaming, is 1.8.

The cell diameter of the finished foam article was measured with an optical microscope; the material density was measured with a specific gravity balance; and the rebound ability was tested according to ASTM D2632: the test was performed by freely falling a standard steel ball with a mass of 28±0.5 g from a height of 400 mm onto the foam plastic sample, where the ratio between the maximum height to which the steel ball rebound and the falling height was calculated as the rebound percentage (rebound degree).

In Example 1, the density, cell diameter, and rebound degree of the finished foam article as measured were 0.16, 0.5-1.5 mm and 55% respectively.

### EXAMPLE 2

A finished foam article was obtained following the same procedure as Example 1, except that an EVA (with a molar content of vinyl acetate of 26%)/POE (POE 8150, from Dow Chemical Corporation) mixture with a mixing ratio of 60/40 was used instead of EVA.

The density, cell diameter, and rebound degree of the finished foam article were 0.13, 0.5-1.5 mm and 60% respectively.

### EXAMPLE 3

A finished foam article was obtained following the same procedure as Example 1, except that an EVA (with a molar content of vinyl acetate of 26%)/POE (POE 8150, from Dow Chemical Corporation) mixture with a mixing ratio of 60/40 was used instead of EVA, and nitrogen supercritical fluid was used instead of carbon dioxide supercritical fluid.

The density, cell diameter, and rebound degree of the finished foam article were 0.15, 0.5-2.5 mm and 60% respectively.

### EXAMPLE 4

A finished foam article was obtained following the same procedure as Example is 1, except that TPU 85AU10 (from Covestro Corporation) was used instead of the EVA and the mixing and crosslinking steps were omitted.

The density, cell diameter, and rebound degree of the finished foam article were 0.28, 0.5-1.0 mm and 55% respectively.

### EXAMPLE 5

A finished foam article was obtained following the same procedure as Example 3, except that no peroxide crosslinking agent was used in the formulation, and a high energy electron beam irradiation process with 20-50 kGy (kilogrey) of high energy electron beam irradiation was performed to crosslink the blank.

The density, cell diameter, and rebound degree of the finished foam article were 0.14, 0.5-2.5mm and 60% respectively.

### Comparative Example 1

A TPU foam product was prepared with a conventional Mucell technology by using a supercritical fluid foaming equipment. The barrel temperature of the injection molding machine was 210° C., and the mold temperature was 30° C. Using a Mucell equipment, a nitrogen supercritical fluid was injected into the metering section of the injection molding machine and mixed with a TPU melt, then the fluid-mixed TPU melt was injection molded into a mold for molding. In the mold cavity, the supercritical fluid was gasified inside and outside the TPU melt and generated internal cells, as a result, an injection molded and foamed TPU article having a dimension the same as that of the mold cavity and non-smooth surface with gas marks was obtained. The density, cell diameter, and rebound degree of the foam product were 0.55, 0.8-1.5 mm and 53% respectively.

### Comparative Example 2

A finished foam article was obtained with a procedure the same as in Example 1,except that the pre-foaming ratio after the supercritical fluid impregnation is more than 1.6. The density, cell diameter, and rebound degree of the foam product were 0.22, 0.5-1.7 mm and 50% respectively.

### Comparative Example 3

The procedure was the same as in Example 1, except that the amount of the crosslinking agent DCP in the formulation of Example 1 was changed to 1.25 phr. The density, cell diameter, and rebound degree of the foam product were 0.32, 0.2-0.8 mm and 40% respectively.

### Comparative Example 4

The procedure was the same as in Example 1, except that the amount of the crosslinking agent DCP in the formulation of Example 1 was changed to 0.12 phr. The density, cell diameter, and rebound degree of the foam product were 0.42, 0.2-0.6 mm and 35% respectively.

### Comparative Example 5

The procedure was the same as in Example 2, except that the amount of the crosslinking agent DCP in the formulation of Example 2 was changed to 0.12 phr. The density, cell diameter, and rebound degree of the foam product were 0.35, 0.1-0.8 mm and 42% respectively.

What is claimed is:

1. A method for physically foaming a polymer material, comprising:
(1) making a thermoplastic elastomer or a polyolefin material into a thermoplastic elastomer blank or a polyolefin blank with an injector, an extruder, or a molding press;
(2) subjecting the polyolefin blank to a crosslinking reaction to obtain a crosslinked polyolefin blank;
(3) subjecting the thermoplastic elastomer blank or the crosslinked polyolefin blank to a high pressure impregnation with a supercritical fluid at a pressure of 10-50 MPa in an autoclave, then releasing the pressure to a normal pressure to obtain a supercritical fluid-impregnated blank; and
(4) placing the supercritical fluid-impregnated blank into an end-product mold to perform an 1:1 in-mold foaming to obtain a finished foam article.

2. The method according to claim 1, wherein, the thermoplastic elastomer comprises at least one of a thermoplastic polyurethane (TPU), a thermoplastic polyester elastomer (TPEE), and a polyether block amide elastomer (Pebax), or a mixture thereof.

3. The method according to claim 1, wherein, the polyolefin material comprises at least one of poly(ethylene-co-vinyl acetate) (EVA), a polyolefin elastomer (POE), and a low density polyethylene (LDPE), or a mixture thereof; or a blend of the above polyolefin material and a rubber material; and the polyolefin material is optionally doped with at least one of a crosslinking agent, a filler, and an auxiliary agent.

4. The method according to claim 3, wherein, the crosslinking agent comprises a peroxide, such as dicumyl peroxide (DCP) and bis(tert-butylperoxyisopropyl)benzene (BIPB).

5. The method according to claim 3, wherein, the filler comprises at least one of calcium carbonate, talc, mica, pottery clay, zinc oxide, and titanium oxide.

6. The method according to claim 3, wherein, the auxiliary agent comprises at least one of paraffin, stearic acid and a salt thereof, or another long-chain fatty acid.

7. The method according to claim 3, wherein, when the crosslinking agent is doped, an amount of the crosslinking agent is 0.15-1.1 parts by weight relative to 100 parts by weight of the polyolefin material; or when no crosslinking agent is doped, the polyolefin blank is subjected to a crosslinking reaction through an electron beam irradiation process with a 20-50 kGy of high energy electron beam irradiation.

8. The method according to claim 1, wherein, the blank comprises a sheet-like shape or a particulate shape.

9. The method according to claim 1, wherein, the supercritical fluid comprises carbon dioxide supercritical fluid and nitrogen supercritical fluid.

10. The method according to claim 9, wherein, the high pressure impregnation with the supercritical fluid is performed at a temperature of 40-150° C. for 0.5-8 hours.

11. The method according to claim 1, wherein, the condition for the in-mold foaming comprises a temperature of 70-150° C. and a foaming time of 5-30 minutes.

12. The method according to claim 1, wherein, the ratio between a linear dimension of the blank before the in-mold foaming and a dimension of the product after the in-mold foaming is 1:1.5 to 1:3.5.

13. A foamed article obtained by the method for physically foaming a polymer material according to claim 1, having a rebound degree of 50% or more as measured according to ASTM D2632.
